(19) United States
(12) Patent Application Publication
(10) Pub. No.: US 2018/0129307 A1
(43) Pub. Date: May 10, 2018

(54) TOUCH CONTROL SYSTEM AND METHOD FOR DETERMINING TILT STATE OF STYLUS DEVICE

(71) Applicant: Acer Incorporated, New Taipei City (TW)

(72) Inventors: Tai Ju, New Taipei City (TW); Chueh-Pin Ko, New Taipei City (TW); Chih-Chiang Chen, New Taipei City (TW); Ching-Piao Kuan, New Taipei City (TW)

(73) Assignee: Acer Incorporated, New Taipei City (TW)

(21) Appl. No.: 15/454,685

(22) Filed: Mar. 9, 2017

(30) Foreign Application Priority Data
Nov. 4, 2016 (TW) 105135840

(51) Int. Cl. G06F 3/038; G06F 3/041; G06F 3/0354; G01L 5/00

(52) U.S. Cl. CPC G06F 3/0383; G01L 5/00; G06F 3/03545; G06F 3/0416

(57) ABSTRACT

A touch control system and a method for determining a tilt state of a stylus device are provided. The touch control system includes a stylus device and a touch panel. In one embodiment, the stylus device is configured to transmit a first wireless signal and a second wireless signal. The touch panel is configured to receive the first wireless signal and the second wireless signal and determine a tilt state of the stylus device relative to the touch panel according to a signal feature of the second wireless signal. Therefore, the determination of the tilt state of the stylus device can be improved.

### CROSS-REFERENCE TO RELATED APPLICATION

This application claims the priority benefit of Taiwan application serial no. 105135840, filed on Nov. 4, 2016. The entirety of the above-mentioned patent application is hereby incorporated by reference herein and made a part of this specification.

### BACKGROUND OF THE INVENTION

### Field of the Invention

The invention relates to an interactive technique of a stylus and a touch panel, particularly relates to a touch control system and a method for determining a tilt state of a stylus device.

### Description of Related Art

In response to some specific application requirements (for example, drawing or note-taking), some portable electronic devices such as smart phones, tablet personal computers (PC), drawing boards, touch notebooks, etc., can be used in collaboration with a stylus to improve user's experience. To use the stylus as an input device, a user may simulate to use a real pen to draw or take notes; in addition, various circuits and/or sensors on the stylus can also be used to provide additional functions. For example, by configuring an active signal transmitter, the stylus may send a wireless signal, and a touch panel may analyze the wireless signal to determine a position, a moving trajectory and/or a moving speed of the stylus. Moreover, by using a gravity sensor and/or a gyroscope, the stylus may detect a tilt state of the stylus itself and transmit the tilt state to the touch panel through a wireless signal. According to the tilt state of the stylus, the touch panel may provide a corresponding operation function to the user in real-time, for example, to change a width and/or a colour of a presented handwriting.

However, in some usage environments (for example, the touch panel is not horizontally placed), the tilt state detected by the stylus itself probably cannot actually reflect a tilt angle of the stylus relative to the touch panel, which may cause a confusion in user's operation.

### SUMMARY OF THE INVENTION

The invention is directed to a touch control system and a method for determining a tilt state of a stylus device, which are adapted to accurately determine the tilt state of the stylus device relative to a touch panel.

An embodiment of the invention provides a touch control system including a stylus device and a touch panel. The stylus device is configured to transmit a first wireless signal and a second wireless signal. The touch panel is configured to receive the first wireless signal and the second wireless signal and determine a tilt state of the stylus device relative to the touch panel according to a signal feature of the second wireless signal.

An embodiment of the invention provides a method for determining a tilt state of a stylus device, which includes following steps: transmitting a first wireless signal and a second wireless signal by the stylus device; and receiving the first wireless signal and the second wireless signal and determining a tilt state of the stylus device relative to the touch panel according to a signal feature of the second wireless signal by a touch panel.

Another embodiment of the invention provides a touch control system including a touch panel and a stylus device. The touch panel is configured to transmit a first wireless signal. The stylus device is configured to receive the first wireless signal and transmit a second wireless signal according to a signal feature of the first wireless signal. The touch panel is further configured to receive the second wireless signal and obtain a tilt state of the stylus device relative to the touch panel according to the second wireless signal.

Another embodiment of the invention provides a method for determining a tilt state of a stylus device, which includes following steps: transmitting a first wireless signal by a touch panel; receiving the first wireless signal and transmitting a second wireless signal according to a signal feature of the first wireless signal by the stylus device; and receiving the second wireless signal and obtaining a tilt state of the stylus device relative to the touch panel according to the second wireless signal by the touch panel.

According to the above descriptions, by analyzing the signal feature of wireless signal transmitted between the stylus device and the touch panel, the influence of a placing angle of the touch panel and/or an operation angle of the stylus device is reduced, such that the tilt state of the stylus device relative to the touch panel can be accurately determined.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch control system according to an embodiment of the invention.

FIG. 2 is a schematic diagram of a stylus device according to a first embodiment of the invention.

FIG. 3 is a diagram illustrating a relationship between a tilt state and a signal feature according to the first embodiment of the invention.

FIG. 4 is a flowchart illustrating a method for determining a tilt state of a stylus device according to the first embodiment of the invention.

FIG. 5 is a schematic diagram of a stylus device according to a second embodiment of the invention.

FIG. 6 is a diagram illustrating a relationship between a tilt state and a signal feature according to the second embodiment of the invention.

FIG. 7 is a schematic diagram of a packet used for transmitting tilt information according to the second embodiment of the invention.

FIG. 8 is a flowchart illustrating a method for determining a tilt state of a stylus device according to the second embodiment of the invention.

### DESCRIPTION OF EMBODIMENTS

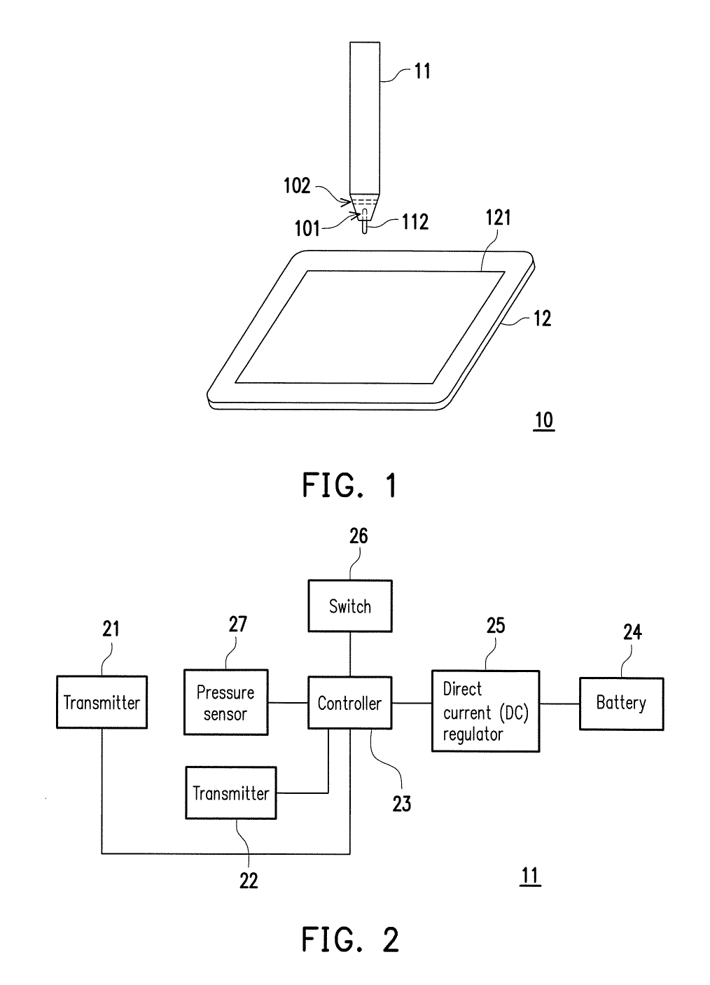

FIG. 1 is a schematic diagram of a touch control system according to an embodiment of the invention. Referring to FIG. 1, the touch control system 10 includes a stylus device 11 and a touch panel 121 (or an electronic device 12). The touch panel 121 is disposed on the electronic device 12. In the present embodiment, the stylus device 11 is, for example, a strip type cylindrical stylus. Though it is noted that in another embodiment, the stylus device 11 may have other shapes (for example, a strip type polygon). Moreover, the electronic device 12 can be any electronic device having the touch panel 121 such as a smart phone, a tablet personal computer (PC), a drawing board or a touch notebook, etc.

In the present embodiment, the touch panel 121 is a capacitive touch panel, and a sensing electrode (or a sensing electrode array) on the touch panel 121 may receive wireless signal coming from the stylus device 11. For example, the sensing electrode on the touch panel 121 may have at least one specific shape to receive the wireless signal transmitted by the stylus device 11 in at least one specific frequency. Moreover, in another embodiment, the touch panel 121 can also be an electromagnetic touch panel, a resistive touch panel or an optical touch panel, etc., and/or the touch panel 121 can be additionally configured with an antenna (or a sensing electrode) with specific shape, so as to receive the wireless signal transmitted by the stylus device 11 in specific frequency.

A front end (which is also referred to as a first endpoint) of the stylus device 11 is configured with a conductor element 112 for transmitting a wireless signal. In an embodiment, the wireless signal is purely used for positioning the stylus device 11 by the touch panel 121. In another embodiment, the stylus device 11 may transmit specific information though the wireless signal, and the touch panel 121 may receive and analyze the wireless signal to obtain the specific information. It is noted that the shape of the conductor element 112 shown in FIG. 1 is merely an example, and in another embodiment, the conductor element 112 can be thicker, finer, longer or shorter.

### First Embodiment

FIG. 2 is a schematic diagram of a stylus device according to the first embodiment of the invention. Referring to FIG. 1 and FIG. 2, in the present embodiment, the stylus device 11 includes a transmitter 21, a transmitter 22, a controller 33, a battery 24 and a direct current (DC) regulator 25. The transmitter 21 is disposed at a position 101 (which is referred to as a first position) and is used for transmitting a wireless signal. For example, the transmitter 21 includes the conductor element 112. The transmitter 22 is disposed at a position 102 (which is referred to as a second position) and is used for transmitting another wireless signal, where the position 102 is located farther from the front end (i.e. the first endpoint) of the stylus device 11 compared with the position 101. For example, the first endpoint is configured to approach (or contact) the touch panel 121 to produce a positioning signal corresponding to the stylus device 11 on the touch panel 121. For example, the positioning signal is a capacitance variation generated by the touch panel 121 at a position where the first endpoint of the stylus device 11 approaches (or contacts). Alternatively, in an embodiment, the touch panel 121 may generate a positioning signal corresponding to the stylus device 11 according to an electric field intensity or an electric field density distribution of a wireless signal transmitted by the transmitter 21. Moreover, the transmitter 22 may also include a conductor element (not shown) to transmit wireless signal. For example, the conductor element of the transmitter 22 is disposed at the position 102 by surrounding a housing of the stylus device 11 from inside or outside of the housing. In another embodiment, a configuration style of the conductor element of the transmitter 22 can be changed as long as the wireless signal can be transmitted.

In the present embodiment, the wireless signal sent by the transmitter 21 is also referred to as a first wireless signal, and the wireless signal sent by the transmitter 22 is also referred to as a second wireless signal, where the first wireless signal is transmitted in a frequency (which is referred to as a first frequency), and the second wireless signal is transmitted in another frequency (which is also referred to as a second frequency), and the first frequency is different from the second frequency. However, in another embodiment, the first frequency can be the same to the second frequency.

In the present embodiment, the controller 23 includes a micro processing unit (MCU) (not shown) and a voltage driving circuit (not shown). The battery 24 is configured to provide a power. The DC regulator 25 is coupled to the battery 24 and is configured to regulate a DC power from the battery 24 to a specific voltage level for the usage of the controller 23. In an embodiment, the DC regulator 25 includes a DC to DC regulator. The controller 23 is coupled to the transmitter 21, the transmitter 22 and the DC regulator 25. The controller 23 may use the power coining from the DC regulator 25 to drive the transmitter 21 and the transmitter 22.

In an embodiment, the stylus device 11 further includes a switch 26 and/or a pressure sensor 27. The switch 26 and the pressure sensor 27 can be respectively coupled to the controller 23. The switch 26 is configured to control to turn on/off the power of the entire stylus device 11, or only control to turn on/off the power of a part of the circuit components (for example, the transmitter 21 and/or the transmitter 22). The pressure sensor 27 is coupled to the front end of the stylus device 11 and is configured to sense a pressure of the front end of the stylus device 11 pushed towards the internal of the stylus device 11. For example, the pressure sensor 27 can be coupled to the conductor element 112 to sense a pressure value of the conductor element 112 pushed towards the internal of the stylus device 11.

In an embodiment, the pressure value sensed by the pressure sensor 27 can also be used for providing a function the same or similar to the function of the switch 26. For example, if the pressure value at the front end of the stylus device 11 is sensed to be higher than a predetermined value, the controller 23 may activate the stylus device 11 or the part of the circuit components. Taking the transmitter 22 as an example, if the pressure value at the front end of the stylus device 11 is sensed to be higher than the predetermined value, it represents that the user is probably using the stylus device 11 to operate the touch panel 121, so that the controller 23 may activate the transmitter 22. In case that the transmitter 22 is activated, if the pressure value at the front end of the stylus device 11 is not higher than the predetermined value for a predetermined time period, it represents that the user probably does not use the stylus device 11 temporarily, so that the controller 23 may turn off the transmitter 22 to save power.

In the present embodiment, the touch panel 121 may receive the first wireless signal (i.e. the wireless signal transmitted by the transmitter 21) and the second wireless signal (i.e. the wireless signal transmitted by the transmitter 22), and a processor (not shown) of the touch panel 121 may determine a tilt state of the stylus device 11 relative to the touch panel 121 according to a signal feature of the second wireless signal. For example, the signal feature of the second wireless signal includes a signal intensity of the second wireless signal, where the signal intensity of the second wireless signal received by the touch panel 121 is positively correlated to the tilt angle of the stylus device 11 relative to the touch panel 121. Namely, the more the stylus device 11 tilts towards the touch panel 121, the higher the signal intensity of the second wireless signal received by the touch panel 121 is. Moreover, in an embodiment, the processor of the touch panel 121 may further determine the tilt state of the stylus device 11 relative to the touch panel 121 by referring to a signal feature of the first wireless signal.

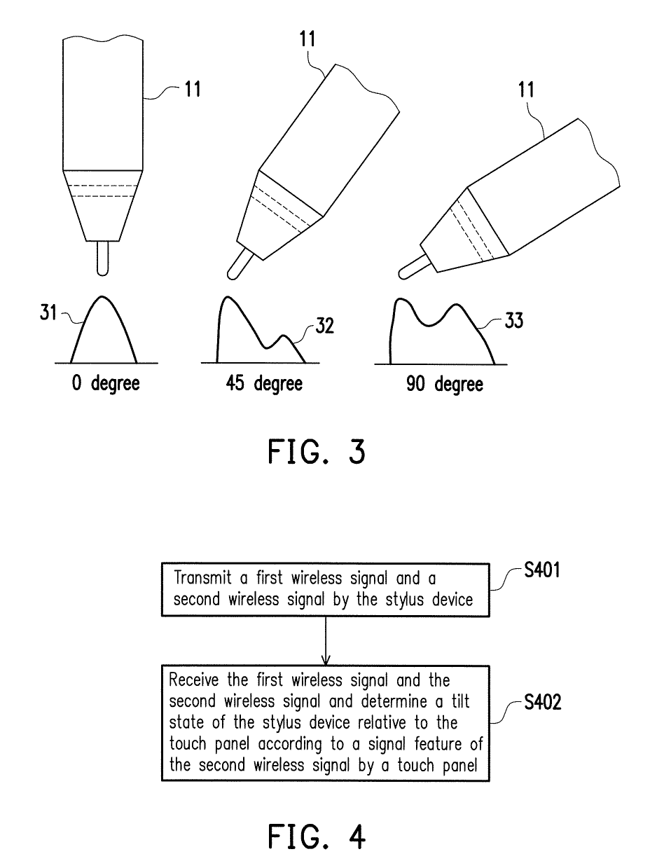

FIG. 3 is a diagram illustrating a relationship between the tilt state and the signal feature according to the first embodiment of the invention. Referring to FIG. 3, when the front end of the stylus device 11 approaches the touch panel 121, if the tilt angle of the stylus device 11 relative to the touch panel 121 is about 0 degree (i.e. the stylus device 11 is nearly perpendicular to the touch panel 121), the signal intensities of the first wireless signal and the second wireless signal detected by the touch panel 121 are the strongest at the front end position of the stylus device 11, and both of the signal intensities are decreased in the surrounding area, as shown by a signal intensity waveform 31. If the tilt angle of the stylus device 11 relative to the touch panel 121 is increased to about 45 degrees, the signal intensity of the first wireless signal detected by the touch panel 121 is still the strongest at the front end position of the stylus device 11, and meanwhile the signal intensity of the second wireless signal is gradually increased at one side of the stylus device 11 tilting towards the touch panel 121, as shown by a signal intensity waveform 32. If the tilt angle of the stylus device 11 relative to the touch panel 121 is continually increased to about 90 degrees, the signal intensity of the first wireless signal detected by the touch panel 121 is still the strongest at the front end position of the stylus device 11, and meanwhile the signal intensity of the second wireless signal is further increased at one side of the stylus device 11 largely tilting towards the touch panel 121, as shown by a signal intensity waveform 33. According to the waveforms 31-33 or similar signal features, the touch panel 121 may determine the tilt state of the stylus device 11 relative to the touch panel 121.

It is noted that FIG. 3 is merely an example, different tilt states of the stylus device 11 relative to the touch panel 121 may produce signal with different signal intensities (or signal densities) at the side of the stylus device 11 tilting towards the touch panel 121. In an embodiment, the controller 23 may pre-divide possible tilt angles (for example, 0 degree to 90 degrees) of the stylus device 11 into N tilt levels and set a plurality of signal feature levels (or intensity levels), where N is a positive integer which may be 2 or greater than 2, and each of the signal feature levels corresponds to one signal intensity (or signal intensity waveform, for example, one of the waveforms 31-33 of FIG. 3). For example, in an embodiment, 15-degree is one tilt level, and N is 6. According to the signal feature level of the detected second wireless signal, the touch panel 121 may determine one of the N tilt levels corresponding to the current tilt state of the stylus device 11 relative to the touch panel 121. Then, the touch panel 121 may execute a corresponding operation and/or display corresponding content according to the determined tilt level (or tilt state), for example, to adjust a width or a color of a handwriting on a display image.

FIG. 4 is a flowchart illustrating a method for determining a tilt state of a stylus device according to the first embodiment of the invention. Referring to FIG. 1 and FIG. 4, in the step S401, the stylus device 11 transmits the first wireless signal and the second wireless signal. In step S402, the touch panel 121 receives the first wireless signal and the second wireless signal and determines a tilt state of the stylus device 11 relative to the touch panel 121 according to a signal feature of the second wireless signal. It is noted that details of various steps of FIG. 4 have been described in the above description, so that descriptions thereof are not repeated.

### Second Embodiment

A difference between the second embodiment and the first embodiment is that in the second embodiment, a receiver is configured at the position 102 of FIG. 1 to receive a wireless signal from the touch panel 121. The stylus device 11 may correspondingly send a wireless signal according to a signal feature of the received wireless signal. Then, the touch panel 121 may receive the wireless signal coming from the stylus device 11 and obtains the tilt state of the stylus device 11 relative to the touch panel 121 according to the wireless signal, and then executes a specific function.

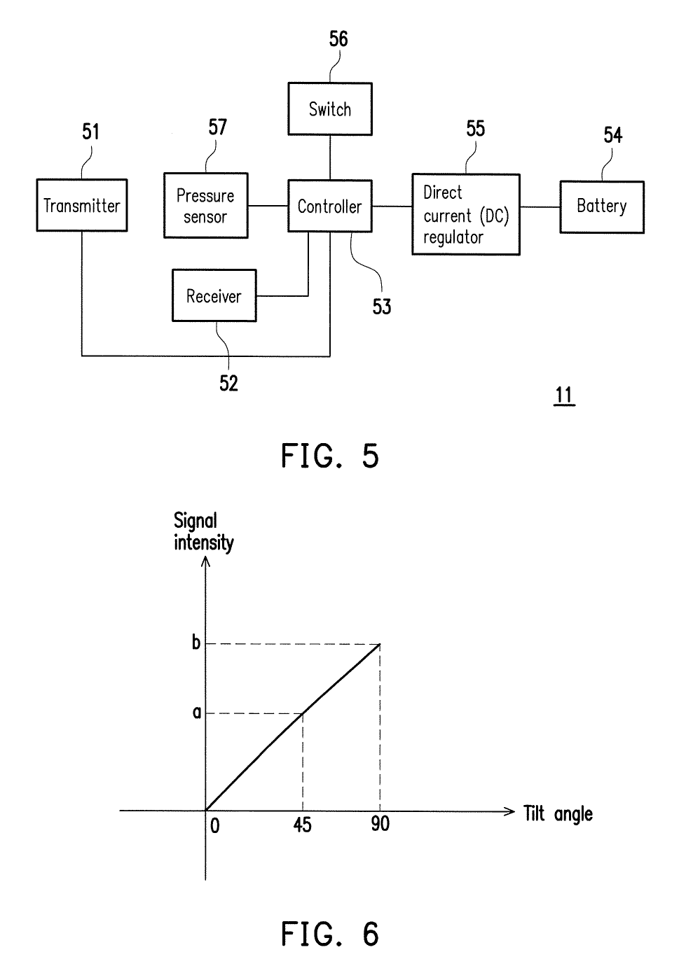

FIG. 5 is a schematic diagram of a stylus device according to the second embodiment of the invention. Referring to FIG. 1 and FIG. 5, in the present embodiment, the stylus device 11 includes a transmitter 51, a receiver 52, a controller 53, a battery 54 and a DC regulator 55. The transmitter 51 is disposed at the position 101, and the receiver 52 is disposed at the position 102. The battery 54 and the DC regulator 55 are the same or similar to the battery 24 and the DC regulator 25 of FIG. 2, and details thereof are not repeated. Moreover, in an embodiment, the stylus device 11 also includes a switch 56 and a pressure sensor 57. A difference between the switch 56 and the pressure sensor 57 of FIG. 5 and the switch 26 and the pressure sensor 26 of FIG. 2 is that in the embodiment of FIG. 5, the switch 56 and/or the pressure sensor 57 can also be used to turn on/off the receiver 52. Taking the pressure sensor 57 as an example, if the pressure sensor 57 detects that the pressure value at the front end of the stylus device 11 is greater than the predetermined value, the controller 53 may activate the receiver 52; otherwise, the controller 53 may maintain the receiver 52 at turn-off state. Other operations of the switch 56 and the pressure sensor 57 are the same or similar to that of the switch 26 and the pressure sensor 27 of FIG. 2, and details thereof are not repeated.

In the present embodiment, the receiver 52 receives a wireless single from the touch panel 121. In the present embodiment, the wireless signal coming from the touch panel 121 is also referred to as a first wireless signal, and is, for example, a wireless signal sent by a sensing electrode or any radiator element on the touch panel 121. The controller 53 may determine tilt information according to a signal feature of the first wireless signal (i.e. the wireless signal coming from the touch panel 121), where the tilt information indicates a tilt angle of the stylus device 11 relative to the touch panel 121. For example, the tilt angle can be an actual angle or the tilt level mentioned in the first embodiment. For example, the signal feature of the first wireless signal includes a signal intensity of the first wireless signal, and the signal intensity of the first wireless signal detected by the stylus device 11 is positively correlated with the tilt angle of the stylus device 11 relative to the touch panel 121.

FIG. 6 is a diagram illustrating a relationship between a tilt state and a signal feature according to the second embodiment of the invention. Referring to FIG. 6, in the second embodiment, when the front end of the stylus device 11 approaches the touch panel 121, if the tilt angle of the stylus device 11 relative to the touch panel 121 is about 0 degree (i.e. the stylus device 11 is nearly perpendicular to the touch panel 121), the signal intensity of the first wireless signal received by the receiver 52 is very small. As the stylus device 11 gradually tilts towards the touch panel 121, the receiver 62 gradually approaches the touch panel 121, such that the signal intensity of the first wireless signal received by the receiver 52 becomes stronger, as shown in FIG. 6. It is noted that although a rough linear relationship of FIG. 6 is used to describe the signal intensity of the first wireless signal and the tilt angle of the stylus device 11 relative to the touch panel 121, the relationship between the signal intensity of the first wireless signal and the tilt angle can be non-linear, which is not limited by the invention. For example, when the tilt angle of the stylus device 11 relative to the touch panel 121 is about 45 degrees, the signal intensity of the first wireless signal received by the receiver 52 is represented by “a”. When the stylus device 11 is further tilted towards the touch panel 121, for example, to 90 degrees, the signal intensity of the first wireless signal received by the receiver 52 is represented by “b”, where a value of “b” is greater than a value of “a”. Therefore, the tilt angle (or the tilt state) of the stylus device 11 relative to the touch panel 121 can be correspondingly determined according to the signal feature (for example, the signal intensity) of the first wireless signal.

Alternatively, similar to the first embodiment, the controller 53 may also pre-divide possible tilt angles (for example, 0 degree to 90 degrees) into N tilt levels and set a plurality of signal feature levels (or intensity levels), where each of the signal feature levels corresponds to one signal intensity. According to the signal feature level of the detected first wireless signal, the controller 53 may determine one of the N tilt levels to which the current tilt state of the stylus device 11 relative to the touch panel 121 belongs. Details may refer to the description of the first embodiment, which are not repeated.

After the tilt angle (or the tilt level) is obtained, the controller 53 may control the transmitter 51 to transmit a wireless signal, such that related tilt information is carried by the wireless signal and transmitted to the touch panel 121. In the present embodiment, the wireless signal transmitted by the transmitter 51 is also referred to as a second wireless signal. After the second wireless signal is received, the processor of the touch panel 121 may analyze the second wireless signal to obtain the tilt information carried by the second wireless signal, so as to obtain the tilt state of the stylus device 11 relative to the touch panel 121.

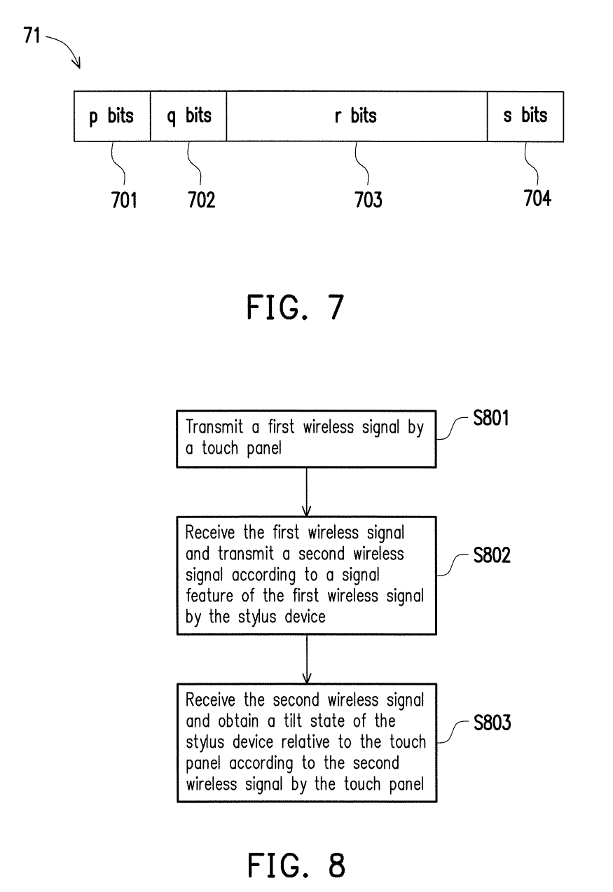

FIG. 7 is a schematic diagram of a packet used for transmitting the tilt information according to the second embodiment of the invention. Referring to FIG. 7, the packet 71 can be used for transmitting the tilt information. For example, the packet 71 includes fields 701-704. The field 701 has p bits and is used for transmitting synchronization information for synchronization. For example, p is 2. The field 702 has q bits and is used for transmitting the tilt information. For example, in the embodiment where 15-degree is taken as one tilt level (i.e. N is 6), q is 3. The field 703 has r bits, and the bit number thereof is not limited. The field 703 is used for transmitting other control information. For example, the control information may include a control signal sent by the stylus device 11, which represents a button of the stylus device 11 being pressed and/or a pressure value detected by the stylus device 11. Moreover, the field 704 has s bits and is used for transmitting packet authentication information, and for example, s is 2. By analyzing the packet 71, the processor of the touch panel 121 may execute the corresponding operation according to the tilt information in the packet 71.

FIG. 8 is a flowchart illustrating a method for determining a tilt state of a stylus device according to the second embodiment of the invention. Referring to FIG. 1 and FIG. 8, in step S801, the touch panel 121 transmits a first wireless signal. In step S802, the stylus device 11 receives the first wireless signal and transmits a second wireless signal according to a signal feature of the first wireless signal. In step S803, the touch panel 121 receives the second wireless signal and obtains a tilt state of the stylus device 11 relative to the touch panel 121 according to the second wireless signal. It is noted that details of the various steps of FIG. 8 have been described in the aforementioned description, so that descriptions thereof are not repeated.

In summary, by analyzing the signal feature of the wireless signal transmitted between the stylus device and the touch panel, the bad influence of a placing angle of the touch panel and/or an operation angle of the stylus device can be reduced, such that the tilt state of the stylus device relative to the touch panel can be accurately determined. Moreover, the invention can be used independently, or can be used in collaboration with the electronic component capable of determining the tilt angle of the stylus device itself such as a gravity sensor (or a gyroscope) built in the stylus device, etc., so as to modify the sensing results of the devices.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch control system, comprising:
a stylus device, configured to transmit a first wireless signal and a second wireless signal; and
a touch panel, configured to receive the first wireless signal and the second wireless signal and determine a tilt state of the stylus device relative to the touch panel according to a signal feature of the second wireless signal.

2. The touch control system as claimed in claim 1, wherein the stylus device comprises:
a first transmitter, disposed at a first position of the stylus device and configured to transmit the first wireless signal; and
a second transmitter, disposed at a second position of the stylus device and configured to transmit the second wireless signal,
wherein the second position is located farther from a first endpoint of the stylus device compared with the first position,
wherein the first endpoint is configured to approach the touch panel to produce a positioning signal on the touch panel.

3. The touch control system as claimed in claim 1, wherein the first wireless signal is transmitted in a first frequency, the second wireless signal is transmitted in a second frequency, and the first frequency is different from the second frequency.

4. The touch control system as claimed in claim 1, wherein the signal feature of the second wireless signal comprises a signal intensity of the second wireless signal, wherein the signal intensity of the second wireless signal received by the touch panel is positively correlated with a tilt angle of the stylus device relative to the touch panel.

5. The touch control system as claimed in claim 1, wherein the touch panel is further configured to generate a positioning signal corresponding to the stylus device according to the first wireless signal.

6. A method for determining a tilt state of a stylus device, comprising:
transmitting a first wireless signal and a second wireless signal by the stylus device; and
receiving the first wireless signal and the second wireless signal and determining a tilt state of the stylus device relative to the touch panel according to a signal feature of the second wireless signal by a touch panel.

7. A touch control system, comprising:
a touch panel, configured to transmit a first wireless signal; and
a stylus device, configured to receive the first wireless signal and transmit a second wireless signal according to a signal feature of the first wireless signal,
wherein the touch panel is further configured to receive the second wireless signal and obtain a tilt state of the stylus device relative to the touch panel according to the second wireless signal.

8. The touch control system as claimed in claim 7, wherein the stylus device comprises:
a receiver, configured to receive the first wireless signal;
a transmitter, configured to transmit the second wireless signal; and
a controller, coupled to the receiver and the transmitter,
wherein the controller is configured to determine a tilt information carried by the second wireless signal according to the signal feature of the first wireless signal,
wherein the tilt information indicates a tilt angle of the stylus device relative to the touch panel.

9. The touch control system as claimed in claim 7, wherein the transmitter is disposed at a first position of the stylus device,
wherein the receiver is disposed at a second position of the stylus device,
wherein the second position is located farther from a first endpoint of the stylus device compared with the first position,
wherein the first endpoint is configured to approach the touch panel to produce a positioning signal on the touch panel.

10. The touch control system as claimed in claim 8, wherein the stylus device further comprises a pressure sensor coupled to the controller and configured to sense a pressure value at the first endpoint,
wherein the controller activates the receiver if the pressure value is greater than a predetermined value.

11. The touch control system as claimed in claim 7, wherein the signal feature of the first wireless signal comprises a signal intensity of the first wireless signal, wherein the signal intensity of the first wireless signal detected by the stylus device is positively correlated with a tilt angle of the stylus device relative to the touch panel.

12. A method for determining a tilt state of a stylus device, comprising:
transmitting a first wireless signal by a touch panel;
receiving the first wireless signal and transmitting a second wireless signal according to a signal feature of the first wireless signal by the stylus device; and
receiving the second wireless signal and obtaining a tilt state of the stylus device relative to the touch panel according to the second wireless signal by the touch panel.
